(19) United States
(12) Patent Application Publication
(10) Pub. No.: US 2009/0273317 A1
(43) Pub. Date: Nov. 5, 2009

(54) INTELLIGENTIZED HIGH-FREQUENCY CHARGER FOR BATTERIES

(75) Inventors: YePing Fan, Shanghai (CN); ChengChuo Hu, Shanghai (CN); DeJin Xu, Shanghai (CN)

Correspondence Address: VIDAS, ARRETT & STEINKRAUS, P.A., SUITE 400, 6640 SHADY OAK ROAD, EDEN PRAIRIE, MN, 55344, US

(73) Assignee: SHANGHAI GREATWAY TOP POWER CO., LTD., Shanghai (CN)

(21) Appl. No.: 12/296,445

(22) PCT Filed: Jul. 27, 2006
(86) PCT No.: PCT/CN06/01877

§ 371 Date: Oct. 8, 2008

(30) Foreign Application Priority Data
Jul. 21, 2006 (CN) CN 200610029201.X

(51) Int. Cl. H02J 7/04; H02J 7/16

(52) U.S. Cl. 320/145; 320/165

(57) ABSTRACT

An intelligentized high-frequency charger for batteries includes a monolithic processor control circuit, a charging control circuit and a detection circuit electrically connected to the said monolithic processor control circuit respectively. The said monolithic processor control circuit includes a monolithic processor, an auxiliary power supply circuit and a key display circuit electrically connected to the said monolithic processor respectively. The said charging control circuit includes a PWM circuit, a drive circuit, a rectifier and filter circuit, an output control circuit and a current sampling circuit. The detection circuit includes a cell detection circuit, a reverse connection detection circuit, a cell voltage detection circuit and an auto pole circuit.

### TECHNICAL FIELD

The present invention relates to a charger for battery, in particular, to an intelligentized high-frequency charger for battery.

### BACKGROUND ART

A typical chargers for battery comprises an industrial frequency transformer and a relatively simple control circuit. The industrial frequency transformer has the relatively large volume and weight, and the charging mode of this charger is in unitary charging mode, and the charging process is relatively slowly. The control circuit sends an output signal once it is powered on, and detects and compares in real time the voltage of the battery, then causes the charging process to come into various charging stages according to the voltage settings, and finally into the float charging stage when it is detected that the battery is fully charged.

When this kind of charger is intended to connect to a battery, its connecting must be prior to its switching on, otherwise, the reverse sequence will cause the electric sparks; meanwhile, it is necessary to inspect carefully whether the battery is connected in the correct polarity; in addition, the phenomenon of short-charging or overcharging is possible often. Above-mentioned issues greatly reduce the reliability, safety and operability of this kind of charger.

### SUMMARY

The object of the present invention is to provide an intelligentized high-frequency charger for battery which adopts the high-frequency technology and is combined with a single-chip microcomputer. When connected with a battery, the charger can detect automatically the existence of the battery and judge the polarity thereof so as to make the battery operate normally no matter whether it is in the normal or reverse connection, in addition, the charger adopts the “intermittent” mode to sample the voltage of the battery according to the rising characteristics of the voltage of the battery being charged so as to ensure the battery not to be over-charged or short-charged. Therefore, the present invention operates efficiently, simply and safely, saves the power and has the enhanced operability.

In order to achieve the above object, the present invention provides an intelligentized high-frequency charger for battery comprising a control circuit with single-chip microcomputer, a charging control circuit and a detecting circuit, the latter two being connected in circuit to said control circuit with single-chip microcomputer respectively.

Said control circuit with single-chip microcomputer comprises a single-chip microcomputer, and an auxiliary power supply circuit and a press-key displaying circuit which are connected in circuit to said single-chip microcomputer respectively.

Said single-chip microcomputer controls entirely the operation of the intelligentized high-frequency charger for battery as a whole.

When the charger of the invention is powered on, said auxiliary power supply circuit produces the required auxiliary power supplies by means of an auxiliary transformer.

Said press-key displaying circuit comprises the several press-keys and the several indicating lights for indicating the operating state of the battery as a whole which are connected in circuit.

Said charging control circuit comprises a pulse-width modulating circuit, a driving circuit, a rectifying and filtering circuit, an output control circuit and a current sampling circuit.

The input end of said pulse-width modulating circuit is connected in circuit to the output end of said single-chip microcomputer; the input end of said driving circuit is connected in circuit to the output end of said pulse-width modulating circuit; the input end of said rectifying and filtering circuit is connected in circuit to the output end of said driving circuit; the input end of said output control circuit is connected in circuit to the output end of said rectifying and filtering circuit and the output end of said single-chip microcomputer, and the output end thereof is connected in circuit to said pulse-width modulating circuit and the battery; and said current sampling circuit obtains the current value by means of the current sampling transformer and is connected in circuit to said pulse-width modulating circuit and said single-chip microcomputer respectively.

Said pulse-width modulating circuit comprises a pulse-width modulating chip and a periphery circuit connected to said pulse-width modulating chip.

Moreover, said pulse-width modulating circuit further comprises a current-limit protective circuit connected to said current sampling circuit and said driving circuit.

Said driving circuit comprises the several driving transformers and driving logic circuits which are connected in circuit successively and the several power switching transistors.

Moreover, said charging control circuit further comprises a temperature detecting circuit connected to said single-chip microcomputer and a battery discharging circuit connected in circuit to said single-chip microcomputer and the battery respectively.

Said detecting circuit comprises a battery detecting circuit, a reverse-connection detecting circuit, a battery voltage detecting circuit and an automatic polarity circuit; the input end of said battery detecting circuit is connected in circuit to said battery, and the output end thereof is connected in circuit to said single-chip microcomputer; the input end of said reverse-connection detecting circuit is connected in circuit to said battery, and the output end thereof is connected in circuit to said single-chip microcomputer; the input end of said battery voltage detecting circuit is connected in circuit to said battery, and the output end thereof is connected in circuit to said single-chip microcomputer; the input end of said automatic polarity circuit is connected in circuit to said single-chip microcomputer, and the output end thereof is connected in circuit to said battery.

When the intelligentized high-frequency charger for battery of the invention is powered on, the power supply indicating light in the press-key displaying circuit is on, and the auxiliary power supply circuit produces the required auxiliary power supplies by means of the auxiliary transformer.

The battery detecting circuit detects the existence of the battery and will produce, while detecting, a high-level signal to be sent to the single-chip microcomputer if the battery exists, or a low-level signal if the battery doesn't do; if no battery exists, the single-chip microcomputer sends a low-level signal to the output control circuit, in this time, the press-keys in the press-key displaying circuit are unavailable, the program doesn't run and the charge doesn't provide the output, on the contrary, if the battery exists, the reverse-connection detecting circuit will detect whether the battery is connected in the correct polarity and send a detecting result in the forms of high-level or low-level to the single-chip microcomputer; if the battery is connected in the reverse polarity, the single-chip microcomputer controls the automatic polarity circuit to bring the battery to the correct polarity in connection, and the size of the charging current can be selected by the press-keys in the press-key displaying circuit as long as the battery is connected in the correct polarity; in this time, the battery voltage detecting circuit detects the end voltage of the connected battery, converts the voltage and sends it to the single-chip microcomputer; the single-chip microcomputer compares the voltage value with preset values U1, U2 and U3 to judge which stages the charging process should come into, that is, the charging process should come into the recovery charging stage i.e. be charged in ¼ constant current if the detected voltage value U is lower than U1; or come into constant current stage if U1<U<U2; or come into constant voltage stage if U2<U<U3; or come into the float stage to be charged in very small current if U3<U, in this time, the voltage of the battery rises very slowly.

The single-chip microcomputer provides the correct control signals of the control voltage and the pulse-width modulating current to the pulse-width modulating circuit, and the pulse-width modulating circuit performs comparison and outputs two sets of pulse driving signals which are sent to the driving logic circuit via the driving transformer to drive the power switching transistors; meanwhile, a current-limit protective circuit for current-limit protection is provided, which is directed against the significantly large current passing through after the driving logic circuit is driven by the driving signals, the current-limit protective circuit being achieved through the control on the pulse-width modulation by the single-chip microcomputer; the rectifying and filtering circuit rectifies and filters the current signals to obtain the good ones; the current signals obtained by the current sampling circuit are output to the pulse-width modulating circuit and the single-chip microcomputer after they ate amplified and operated, and the single-chip microcomputer outputs the corresponding pulse-width waveform, then, if the current obtained by the single-chip microcomputer in this time is smaller than the rated current, the single-chip microcomputer adjusts correctly the output of the control voltage to maintain the current in a specified range; and if the current obtained by the single-chip microcomputer in this time is larger than the rated current, the single-chip microcomputer will also adjust correctly the output of the control voltage and change the pulse driving signals of the pulse-width modulating circuit, in order to control the ON time of the power switching transistors in the driving logic circuit by controlling the duty ratio (the duty ratio is the proportion the high-level accounts for in a unit period).

When the timed count of timer T1 in the program of the single-chip microcomputer amounts to the specified value, the single-chip microcomputer outputs a control signal to stop the output of the pulse-width modulating circuit and shut off all power switching transistors in order to stop the output of the circuit as a whole, meanwhile, the single-chip microcomputer outputs a control signal to connect the battery with the battery discharging circuit in order to discharge the battery in a short duration, then outputs a control signal to disconnect the battery from the battery discharging circuit when preset discharging time T2 elapses, in this time, the battery voltage detecting circuit detects the end voltage of the battery and sends the A/D (Analog/Digital)-converted detecting result to the single-chip microcomputer, then the single-chip microcomputer compares the voltage detecting value with the preset value to judge the charging stage and continues the charge.

During a normal charging process, the intelligentized high-frequency charger of the invention ceases the charge at regular intervals and connects the battery with the battery discharging circuit in the duration when the charge is ceased in order to discharge the battery in a snort duration, meanwhile, the battery voltage detecting circuit detects the end voltage of the battery and sends the A/D-converted detecting result to the single-chip microcomputer, and when the discharging time elapses, the single-chip microcomputer compares the detecting value sent by the battery voltage detecting circuit last time with the preset value to judge the charging stage and continues the charge. The above operating process is repeated once every the same duration until the battery is fully charged, in this time, the charger stops its operation automatically and completes the charging process.

During the charging process, if the temperature detecting circuit detects that the temperature reaches a protective temperature-limit even goes beyond it, the temperature detecting circuit provides a level signal to the single-chip microcomputer, and the single-chip microcomputer receiving the signal sends a control signal to unactuate the pulse-width modulating circuit in order to stop outputting the pulse driving signals of the pulse-width modulating circuit and shut off the power switching transistors, so that the circuit as a whole has no output and the charging process stops; when the “start/stop” press-key in the press-key displaying circuit is pressed again, the temperature detecting circuit will detect the temperature once more, and if the temperature is below the protective temperature-limit, the battery voltage detecting circuit sends the end voltage of the battery which is detected and A/D converted to the single-chip microcomputer, then the single-chip microcomputer compares the voltage detecting value with the preset value to judge the charging stage and continues the charge.

The present invention provides an intelligentized high-frequency charger for battery which adopts the high-frequency technology and is combined with a single-chip microcomputer. When connected with a battery, the charger can detect automatically the existence of the battery and judge whether the battery is connected in the correct polarity, if incorrect, it connects the wrong polarity, so that the circuit can operate normally, or the circuit has no output in the case that no battery exists or the battery is connected in the reverse polarity; and the correct output can be provided as long as the above two conditions are satisfied and the “start” press-key is pressed. According to the rising characteristics of voltage of the battery being charged, the present invention adopts the “intermittent” mode to sample the voltage of the battery so as to ensure the battery not to be over-charged or short-charged. Therefore, the present invention operates efficiently, simply and safely, saves the power, has the enhanced operability and is applicable to the batteries having the various capacities.

### BRIEF DESCRIPTION OF ACCOMPANYING DRAWING

The present invention will be described with reference to the accompanying drawing, in which

FIG. 1 is a schematic principle drawing of the circuit configuration of the intelligentized high-frequency charger for battery of the present invention.

### DETAILED DESCRIPTION OF PREFERRED EMBODIMENT

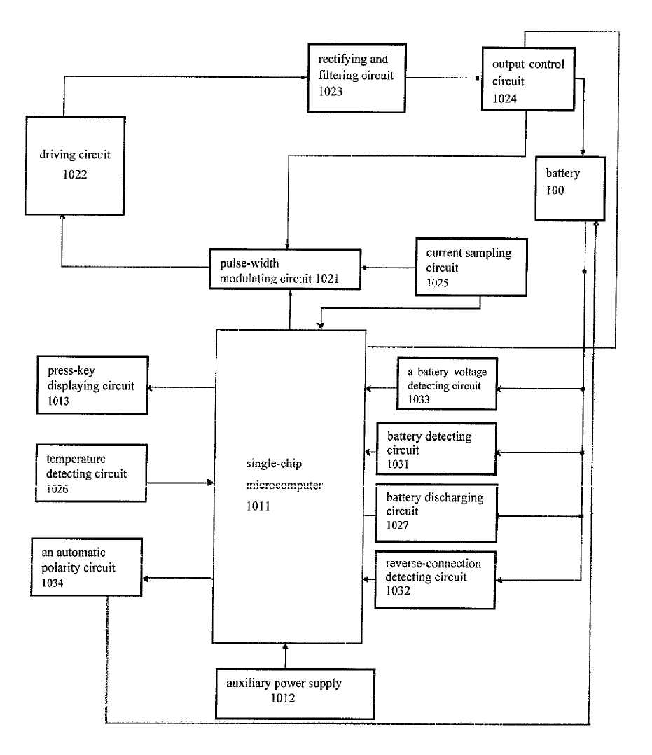

The preferred embodiment of the present invention will be described in detail with reference to FIG. 1.

As shown in FIG. 1, the present invention provides an intelligentized high-frequency charger for battery comprising a control circuit with single-chip microcomputer, a charging control circuit and a detecting circuit, the latter two being connected in circuit to said control circuit with single-chip microcomputer respectively.

Said control circuit with single-chip microcomputer comprises single-chip microcomputer 1011, and auxiliary power supply circuit 1012 and press-key displaying circuit 1013 which are connected in circuit to said single-chip microcomputer 1011 respectively.

Said single-chip microcomputer 1011 controls entirely the operation of the intelligentized high-frequency charger for battery as a whole.

When the charger of the invention is powered on, said auxiliary power supply circuit 1012 produces the required auxiliary power supplies by means of an auxiliary transformer.

Said press-key displaying circuit 1013 comprises the several press-keys and the several indicating lights for indicating the operating state of the battery as a whole which are connected in circuit.

Said charging control circuit comprises pulse-width modulating circuit 1021, driving circuit 1022, rectifying and filtering circuit 1023, output control circuit 1024 and current sampling circuit 1025.

The input end of said pulse-width modulating circuit 1021 is connected in circuit to the output end of said single-chip microcomputer 1011; the input end of said driving circuit 1022 is connected in circuit to the output end of said pulse-width modulating circuit 1021; the input end of said rectifying and filtering circuit 1023 is connected in circuit to the output end of said driving circuit 1022; the input end of said output control circuit 1024 is connected in circuit to the output end of said rectifying and filtering circuit 1023 and the output end of said single-chip microcomputer 1011, and the output end thereof is connected in circuit to said pulse-width modulating circuit 1021 and battery 100; and said current sampling circuit 1025 is connected in circuit to said pulse-width modulating circuit 1021 and said single-chip microcomputer 1011 respectively.

Said pulse-width modulating circuit 1021 comprises a pulse-width modulating chip and a periphery circuit connected to said pulse-width modulating chip.

Moreover, said pulse-width modulating circuit 1021 further comprises a current-limit protective circuit connected to said current sampling circuit 1025 and driving circuit 1022.

Said driving circuit 1022 comprises the several driving transformers and driving logic circuits which are connected in circuit successively and the several power switching transistors.

Moreover, said charging control circuit further comprises temperature detecting circuit 1026 connected to said single-chip microcomputer 1011 and battery discharging circuit 1027 connected in circuit to said single-chip microcomputer 1011 and battery 100 respectively.

Said detecting circuit comprises battery detecting circuit 1031, reverse-connection detecting circuit 1032, battery voltage detecting circuit 1033 and automatic polarity circuit 1034; the input end of said battery detecting circuit 1031 is connected in circuit to said battery 100, and the output end thereof is connected in circuit to said single-chip microcomputer 1011; the input end of said reverse-connection detecting circuit 1032 is connected in circuit to said battery 100; the input end of said battery voltage detecting circuit 1033 is connected in circuit to said battery 100, and the output end thereof is connected in circuit to said single-chip microcomputer 1011; the input end of said automatic polarity circuit 1034 is connected in circuit to said single-chip microcomputer 1011, and the output end thereof is connected in circuit to said battery 100.

When the intelligentized high-frequency charger for battery of the invention is powered on, the power supply indicating light in press-key displaying circuit 1013 is on, and auxiliary power supply circuit 1012 produces the required auxiliary power supplies by means of the auxiliary transformer.

Battery detecting circuit 1031 detects the existence of battery 100 and will produce, while detecting, a high-level signal to be sent to single-chip microcomputer 1011 if battery 100 exists, or a low-level signal if battery 100 doesn't do; if no battery 100 exists, single-chip microcomputer 1011 sends a low-level signal to output control circuit 1024, in this time, the press-keys in press-key displaying circuit 1013 are unavailable, the program doesn't run and the charger doesn't provide the output, on the contrary, if battery 100 exists, reverse-connection detecting circuit 1032 will detect whether battery 100 is connected in the correct polarity and send a detecting result in the forms of high-level or low-level to single-chip microcomputer 1011; if battery 100 is connected in the reverse polarity, single-chip microcomputer 1011 controls automatic polarity circuit 1034 to bring battery 100 to the correct polarity in connection, and the size of the charging current can be selected by the press-keys in press-key displaying circuit 1013 as long as battery 100 is connected in the correct polarity; in this time, battery voltage detecting circuit 1033 detects the end voltage of connected battery 100, converts the voltage and sends it to single-chip microcomputer 1011; single-chip microcomputer 1011 compares the voltage value with preset values U1, U2 and U3 to judge which stages the charging process should come into, that is, the charging process should come into the recovery charging stage i.e. be charged in ¼ constant current if the detected voltage value U is lower than U1; or come into constant current stage if U1<U<U2; or come into constant voltage stage if U2<U<U3; or come into the float stage to be charged in very small current if U3<U, in this time, the voltage of battery 100 rises very slowly.

Single-chip microcomputer 1011 provides the correct control signals of the control voltage and the pulse-width modulating current to pulse-width modulating circuit 1021, and pulse-width modulating circuit 1021 performs comparison and outputs to driving circuit 1022 two sets of pulse driving signals which are sent to the driving logic circuit via the driving transformer to drive the power switching transistors; meanwhile, a current-limit protective circuit for current-limit protection is provided, which is directed against the significantly large current passing through after the driving logic circuit is driven by the driving signals, the current-limit protective circuit being achieved through the control on the pulse-width modulation of single-chip microcomputer 1011; rectifying and filtering circuit 1023 rectifies and filters the current signals to obtain the good ones; the current signals obtained by current sampling circuit 1025 axe output to pulse-width modulating circuit 1021 and single-chip microcomputer 1011 after they are amplified and operated, and single-chip microcomputer 1011 outputs the corresponding pulse-width waveform, then, if the current obtained by single-chip microcomputer 1011 in this time is smaller than the rated current, single-chip microcomputer 1011 adjusts correctly the output of the control voltage to maintain the current value in a specified range; and if the current obtained by single-chip microcomputer 1011 in this time is larger than the rated current, single-chip microcomputer 1011 will also adjust correctly the output of the control voltage and change the pulse driving signals of pulse-width modulating circuit 1021, in order to control the ON time of the power switching transistors in the driving logic circuit by controlling the duty ratio (the duty ratio is the proportion the high-level accounts for in a unit period).

When the timed count of timer T1 in the program of single-chip microcomputer 1011 amounts to specified value t1, single-chip microcomputer 1011 outputs a control signal to stop the output of pulse-width modulating circuit 1021 and shut off all power switching transistors in order to stop the output of the circuit as a whole, meanwhile, single-chip microcomputer 1011 outputs a control signal to connect battery 100 with battery discharging circuit 1027 in order to discharge battery 100 in a short duration, then outputs a control signal to disconnect battery 100 from battery discharging circuit 1027 when preset discharging time t2 elapses, in this time, battery voltage detecting circuit 1033 detects the end voltage of battery 100 and sends the A/D-converted detecting result to single-chip microcomputer 1011, then single-chip microcomputer 1011 compares the voltage detecting value with the preset value to judge the charging stage and continues the charge.

During a normal charging process, the intelligentized high-frequency charger of the invention ceases the charge at regular intervals and connects battery 100 with battery discharging circuit 1027 in the duration when the charge is ceased in order to discharge the battery in a short duration, meanwhile, battery voltage detecting circuit 1033 detects the end voltage of battery 100 and sends the A/D-converted detecting result to single-chip microcomputer 1011, and when the discharging time elapses, single-chip microcomputer 1011 compares the detecting value sent by battery voltage detecting circuit 1027 last time with the preset value to judge the charging stage and continues the charge. The above operating process is repeated once every the same duration until the battery is fully charged, in this time, the charger stops its operation automatically and completes the charging process.

During the charging process, if temperature detecting circuit 1026 detects that the temperature reaches a protective temperature-limit even goes beyond it, temperature detecting circuit 1026 provides a level signal to single-chip microcomputer 1011, and single-chip microcomputer 1011 receiving the signal sends a control signal to unactuate pulse-width modulating circuit 1021 in order to stop outputting the pulse driving signals of pulse-width modulating circuit 1021 and shut off the power switching transistors, so that the circuit as a whole has no output and the charging process stops; when the “start/stop” press-key in press-key displaying circuit 1013 is pressed again, temperature detecting circuit 1026 will detect the temperature once more, and if the temperature is below the protective temperature-limit, battery voltage detecting circuit 1033 sends the end voltage of battery 100 which is detected and A/D converted to single-chip microcomputer 1011, then single-chip microcomputer 1011 compares the voltage detecting value with the preset value to judge the charging stage and continues the charge.

The present invention provides an intelligentized high-frequency charger for battery which adopts the high-frequency technology and is combined with a single-chip microcomputer. When connected with a battery, the charger can detect automatically the existence of the battery and judge whether the battery is connected in the correct polarity, if incorrect, it corrects the wrong polarity, so that the circuit can operate normally, or the circuit has no output in the case that no battery exists or the battery is connected in the reverse polarity; and the correct output can be provided as long as the above two conditions are satisfied and the “start” press-key is pressed. According to the rising characteristics of voltage of the battery being charged, the present invention adopts the “intermittent” mode to sample the voltage of the battery so as to ensure the battery not to be overcharged or short-charged. Therefore, the present invention operates efficiently, simply and safely, saves the power, has the enhanced operability and is applicable to the batteries having the various capacities.

1. An intelligentized high-frequency charger for battery, characterized in that the charger comprises a control circuit with single-chip microcomputer, a charging control circuit and a detecting circuit, the latter two being connected in circuit to said control circuit with single-chip microcomputer respectively;
said control circuit with single-chip microcomputer comprises a single-chip microcomputer (1011), and an auxiliary power supply circuit (1012) and a press-key displaying circuit (1013) which are connected in circuit to said single-chip microcomputer (1011) respectively;
said charging control circuit comprises a pulse-width modulating circuit (1021), a driving circuit (1022), a rectifying and filtering circuit (1023), an output control circuit (1024) and a current sampling circuit (1025);
the input end of said pulse-width modulating circuit (1021) is connected in circuit to the output end of said single-chip microcomputer (1011);
the input end of said driving circuit (1022) is connected in circuit to the output end of said pulse-width modulating circuit (1021);
the input end of said rectifying and filtering circuit (1023) is connected in circuit to the output end of said driving circuit (1022);
the input end of said output control circuit (1024) is connected in circuit to the output end of said rectifying and filtering circuit (1023) and the output end of said single-chip microcomputer (1011), and the output end thereof is connected in circuit to said pulse-width modulating circuit (1021) and the battery (100);
the input end of said current sampling circuit (1025) is connected in circuit to the battery (100), and the output end thereof is connected in circuit to said pulse-width modulating circuit (1021) and said single-chip microcomputer (1011) respectively;
said detecting circuit comprises a battery detecting circuit (1031), a reverse-connection detecting circuit (1032), a battery voltage detecting circuit (1033) and an automatic polarity circuit (1034);
the input end of said battery detecting circuit (1031) is connected in circuit to said battery (100), and the output end thereof is connected in circuit to said single-chip microcomputer (1011);
the input end of said reverse-connection detecting circuit (1032) is connected in circuit to said battery (100);
the input end of said battery voltage detecting circuit (1033) is connected in circuit to said battery (100), and the output end thereof is connected in circuit to said single-chip microcomputer (100);
the input end of said automatic polarity circuit (1034) is connected in circuit to said single-chip microcomputer (1011), and the output end thereof is connected in circuit to said battery (100).

2. The intelligentized high-frequency charger for battery according to claim 1, characterized in that said press-key displaying circuit (1013) comprises the several press-keys and the several indicating lights for indicating the operating state of the charger for battery as a whole which are connected in circuit.

3. The intelligentized high-frequency charger for battery according to claim 1, characterized in that said pulse-width modulating circuit (1021) comprises a pulse-width modulating chip and a periphery circuit connected to said pulse-width modulating chip.

4. The intelligentized high-frequency charger for battery according to claim 3, characterized in that said pulse-width modulating circuit (1021) further comprises a current-limit protective circuit connected to said current sampling circuit (1025) and said driving circuit (1022).

5. The intelligentized high-frequency charger for battery according to claim 1, characterized in that said driving circuit (1022) comprises the several driving transformers and driving logic circuits which are connected in circuit successively and the several power switching transistors.

6. The intelligentized high-frequency charger for battery according to claim 1, characterized in that said charging control circuit further comprises a temperature detecting circuit (1026) connected to said single-chip microcomputer (1011).

7. The intelligentized high-frequency charger for battery according to claim 1, characterized in that said charging control circuit further comprises a battery discharging circuit (1027) connected in circuit to said single-chip microcomputer (1011) and the battery (100) respectively.

8. An intelligentized high-frequency charger for battery, characterized in that the charger comprises a control circuit with single-chip microcomputer, a charging control circuit and a detecting circuit, the latter two being connected in circuit to said control circuit with single-chip microcomputer respectively;
said control circuit with single-chip microcomputer comprises a single-chip microcomputer (1011), and auxiliary power supply circuit (1012) and a press-key displaying circuit (1013) which are connected in circuit to said single-chip microcomputer (1011) respectively;
said charging control circuit comprises a pulse-width modulating circuit (1021), a driving circuit (1022), a rectifying and filtering circuit (1023), an output control circuit (1024) and a current sampling circuit (1025);
said detecting circuit comprises a battery detecting circuit (1031), a reverse-connection detecting circuit (1032), a battery voltage detecting circuit (1033) and an automatic polarity circuit (1034).

9. The intelligentized high-frequency charger for battery according to claim 8, characterized in that,
the input end of said pulse-width modulating circuit (1021) is connected in circuit to the output end of said single-chip microcomputer (1011);
the input end of said driving circuit (1022) is connected in circuit to the output end of said pulse-width modulating circuit (1021);
the input end of said rectifying and filtering circuit (1023) is connected in circuit to the output end of said driving circuit (1022);
the input end of said output control circuit (1024) is connected in circuit to the output end of said rectifying and filtering circuit (1023) and the output end of said single-chip microcomputer (1011), and the output end thereof is connected in circuit to said pulse-width modulating circuit (1021) and the battery (100);
the input end of said current sampling circuit (1025) is connected in circuit to the battery (100), and the output end thereof is connected in circuit to said pulse-width modulating circuit (1021) and said single-chip microcomputer (1011) respectively;
the input end of said battery detecting circuit (1031) is connected in circuit to said battery (100), and the output end thereof is connected in circuit to said single-chip microcomputer (1011);
the input end of said reverse-connection detecting circuit (1032) is connected in circuit to said battery (100);
the input end of said battery voltage detecting circuit (1033) is connected in circuit to said battery (100), and the output end thereof is connected in circuit to said single-chip microcomputer (100);
the input end of said automatic polarity circuit (1034) is connected in circuit to said single-chip microcomputer (1011), and the output end thereof is connected in circuit to said battery (100).

10. The intelligentized high-frequency charger, for battery according to claim 8, characterized in that said press-key displaying circuit (1013) comprises the several press-keys and the several indicating lights for indicating the operating state of the charger for battery as a whole which are connected in circuit.

11. The intelligentized high-frequency charger for battery according to claim 8, characterized in that said pulse-width modulating circuit (1021) comprises a pulse-width modulating chip and a periphery circuit connected to said pulse-width modulating chip.

12. The intelligentized high-frequency charger for battery according to claim 11, characterized in that said pulse-width modulating circuit (1021) further comprises a current-limit protective circuit connected to said current sampling circuit (1025) and said driving circuit (1022).

13. The intelligentized high-frequency charger for battery according to claim 8, characterized in that said driving circuit (1022) comprises the several driving transformers and driving logic circuits which are connected in circuit successively and the several power switching transistors.

14. The intelligentized high-frequency charger for battery according to claim 8, characterized in that said charging control circuit further comprises a temperature detecting circuit (1026) connected to said single-chip microcomputer (1011).

15. The intelligentized high-frequency charger for battery according to claim 8, characterized in that said charging control circuit further comprises a battery discharging circuit (1027) connected in circuit to said single-chip microcomputer (1011) and the battery (100) respectively.
